(19) United States
(12) Patent Application Publication
(10) Pub. No.: US 2005/0086385 A1
(43) Pub. Date: Apr. 21, 2005

(54) Passive connection backup

(76) Inventor: Gordon Rouleau, Rosemere (CA)

Correspondence Address: OGILVY RENAULT, 1981 MCGILL COLLEGE AVENUE, SUITE 1600, MONTREAL, QC, H3A2Y3, CA

(21) Appl. No.: 10/687,745

(22) Filed: Oct. 20, 2003

(51) Int. Cl. G06F 15/173; H04L 12/28; H04L 12/56

(52) U.S. Cl. 709/249; 709/245; 709/234; 709/239; 370/908

(57) ABSTRACT

A method and apparatus is disclosed for providing a backup connection method within a primary wide area network access device, allowing a plurality of network devices access to a wide area network using a backup access device, connected to a wide area network and addressable by the primary wide area network access device at the datalink layer and optionally at the network layer.

### CROSS-REFERENCE TO RELATED APPLICATIONS

This is the first application filed for the present invention.

### TECHNICAL FIELD

This invention relates to the field of telecommunications. More precisely, this invention pertains to the field of backup connection device.

### BACKGROUND OF THE INVENTION

Accessing wide area networks (WAN) is very common as more and more computers operate connected to such networks. The Internet is the most popular wide area network for most home users.

Wide area networks are also widely used a lot by corporate users. Such networks are very important in order to access and share data between offices for instance.

It will be appreciated that while a home user may more or less suffer from a loss of connection to a wide area network, such loss of connection to a wide area network may cause major operational problems for corporate users.

Prior art backup connection systems are usually highly dependent on a specific coordination protocol to guarantee no breakdown of communications services when WAN backup is activated or deactivated. Furthermore, such prior art backup connection systems may require a large amount of configuration which may not be desirable.

The skilled addressee will also appreciate that it may be difficult to use prior art backup connection systems when various types of access devices are used. For instance, an infrastructure may have internet access devices which use both ISDN connection devices and xDSL connection devices.

Furthermore, some prior art backup connection systems such as VRRP (RFC-2338) and Hot Standby Protocol (RFC-2281) require that a backup coordination protocol be implemented and configured on all internet access devices. This often limits equipment choices to expensive higher-end products from a single vendor, and increases maintenance/management overhead.

It is also recognized that more and more home and business communication applications today are built on World Wide Web transaction-oriented technology, which is very tolerant to WAN access disruptions.

It is therefore highly desirable to take advantage of the trend identified above, and provide a method and apparatus that will overcome the above-identified drawbacks.

### SUMMARY OF THE INVENTION

It is an object of the invention to provide a backup system to be used in order to provide access to a wide area network in the case of a failure of a wide area network connection device.

Yet another object of the invention is to provide a method for providing backup access to a wide area network in the case of a failure of a wide area network connection device.

According to a first aspect of the invention, there is provided, in a primary access device connecting a first network to a second network over a primary connection, a method for providing a backup connection between the first network and the second network, the method comprising detecting a failure in the primary connection, receiving, at the primary access device, a data packet originating from the first network and having a destination address at a data link layer (ISO layer 2, for example Ethernet), replacing, in the data packet, the destination address with a backup access device address identifying a backup access device capable of providing the backup connection and whereby the replacing of the destination address with the backup access device address allows the transmittal of the received data packet from the first network to the second network over the backup connection.

According to another aspect of the invention, there is provided a backup system for providing a backup connection between a first network and a second network in response to a failure of a regular connection between the first network and the second network, the backup system comprising a backup access device for providing the backup connection and having a backup access device address at a data link layer (ISO layer 2, for example Ethernet), a primary access device, connected to the backup access device, providing the regular connection between the first network and the second network and, in response to the failure, replacing the destination address of an incoming data packet, at the data link layer, with the backup access device address and whereby the replacing of the destination address with the backup access device allows the transmittal of the data packet from the first network to the second network over the backup connection.

One of the characteristics of a passive connection backup system is that it does not operate according to a specialized coordination protocol between the primary and secondary wide area network access devices.

### BRIEF DESCRIPTION OF THE DRAWINGS

Further features and advantages of the present invention will become apparent from the following detailed description, taken in combination with the appended drawings, in which:

FIG. 1 is a block diagram which shows a first embodiment of a backup connection system;

FIG. 2 is a block diagram which shows the first embodiment of the backup connection system in the case where a connection between a primary wide area network access device and a wide area network is broken;

FIG. 3 is a flowchart which shows a method for providing a backup connection in accordance with an embodiment of the invention;

FIG. 4 is a block diagram which shows another embodiment of the backup connection system;

FIG. 5 is a block diagram which shows the preferred embodiment of the backup connection system in the case where a link between a primary internet access device and the Internet is broken;

FIG. 6 is a flowchart which shows how a method for providing a backup connection in accordance with one embodiment of the invention; and

FIG. 7 is a flowchart which shows how network layer (ISO layer 3) Internet Domain Name Service (DNS) requests are handled as a consequence of the preferred embodiment of the backup connection system operating at the datalink layer (ISO layer 2).

It will be noted that throughout the appended drawings, like features are identified by like reference numerals.

### DETAILED DESCRIPTION OF THE PREFERRED EMBODIMENT

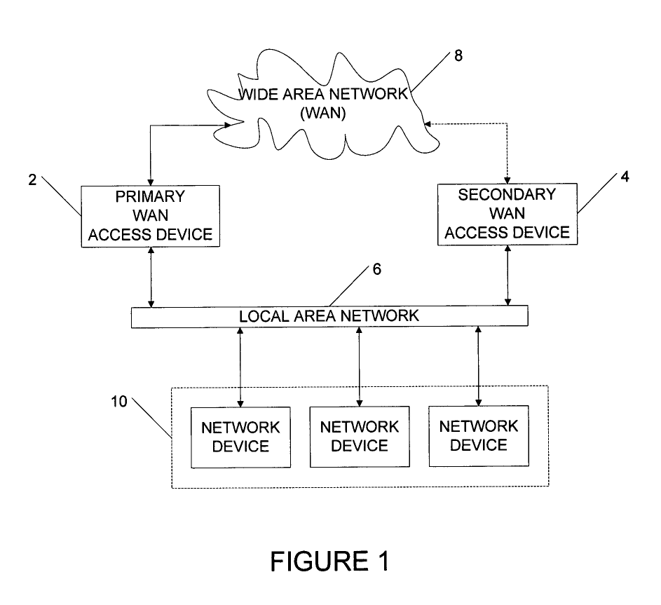

Now referring to FIG. 1, there is shown a first embodiment of a passive connection backup system.

A plurality of network devices 10 are connected to a local area network 6 (LAN). Each of the plurality of network devices is intended to be connected to a wide area network 8. It will be appreciated that a network device may be any one of a computer, a dedicated network processing server, a router, an application gateway or the like.

The passive connection backup system comprises a primary wide area network access device 2 and a secondary wide area network access device 4.

The primary wide area network access device 2 is connected to the wide area network 8 and to the local area network 6. The primary wide area network access device 2 therefore provides an access to the wide area network 8 via the local area network 6 to the plurality of network devices 10. The primary wide area network access device 2 further manages the backup function as explained below.

The secondary wide area network access device 4 is connected to the wide area network 8 and to the local area network 6. The secondary wide area network access device 4 is intended to provide a backup connection to the wide area network 8 via the local area network 6 to the plurality of network devices 10 as explained below. The skilled addressee will appreciate that while a connection is shown in FIG. 1 between the wide area network 8 and the secondary wide area network access device 4, it should be understood that such connection is set preferably only in case of a backup mode, i.e., when a failure occurs in a primary connection between the wide area network 8 and the primary wide area network access device 2. Furthermore, while it has been disclosed that the secondary wide area network access device 4 connects to the wide area network 8, the skilled addressee will appreciate that alternatively, the secondary wide area network access device 4 may connect to another wide area network not shown in FIG. 1.

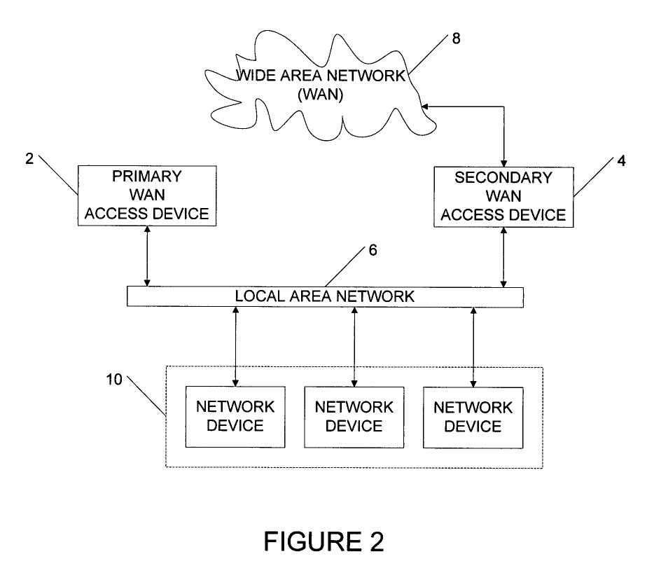

Now referring to FIG. 2, there is shown the first embodiment of the passive connection backup system in the case where the connection between the wide area network 8 and the primary wide area network access device 2 does not operate. It will be appreciated that the connection between the wide area network 8 and the primary wide area network access device 2 may not operate for a plurality of reasons summarized as a failure of the wide area network's 8 service provider equipment.

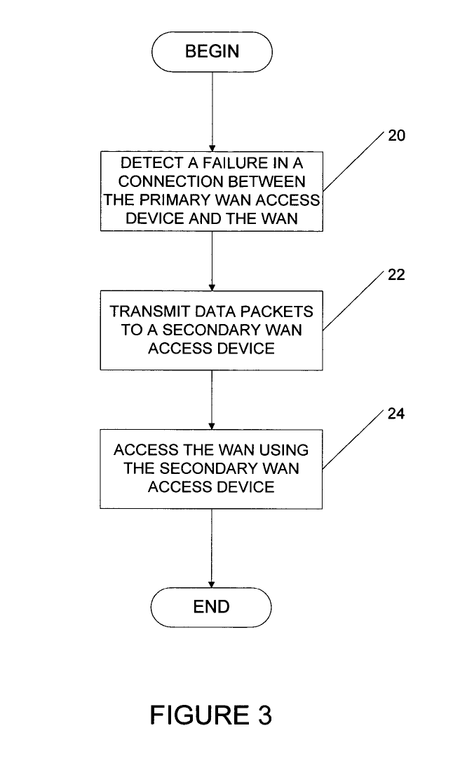

Now referring to FIG. 3, there is shown how the first embodiment of the passive connection backup system operates.

According to step 20, a failure is detected in a connection between the primary wide area network access device 2 and the wide area network 8.

The failure is preferably detected by the primary wide area network access device 2. Such failure may be detected by noting a network failure at ISO layer 1. The network failures at ISO layer 1 comprises, but are not limited to a loss of xDSL or ISDN frame synchronization or a PSTN carrier loss. Alternatively, the failure may be detected by noting a failure at ISO layer 2 framing, for instance with ATM AAL1-AAL5 or HDLC errors. Alternatively, the failure may be detected by noting a failure at layer 2 connection, for instance with ATM OAM AIS/RDI/LB/CC error signaling or PPP/PPPoE datalink connection failure. Alternatively, the failure may be indirectly detected using ISO layer 3 network failures, for instance in IP-based networks with ICMP packet handling errors, IGMP/RIP/OSPF/BGP4 or other routing protocol errors, or using ISO layer 4, for instance in IP-based networks via TCP connection failures or UDP timeouts, or alternatively with higher ISO layers 5, 6, and 7.

According to step 22, data packets received by the primary wide area network access device 2 are transmitted to the secondary wide area network access device 4. As shown in FIG. 2, the secondary wide area network access device 4 is connected to the wide area network 8. Preferably, the transmittal is achieved by replacing the layer 2 destination address within each data packet with the layer 2 address of the secondary wide area network access device 4. Such changes are performed on data packet ISO datalink layer 2 addresses, which are used for sending data packets across the next layer 2 network segment towards their ultimate destination. As known by the skilled addressee, layer 2 is below and independent of the ISO network layer 3 which is used for routing data packets across one or more layer 2 network segments.

According to step 24, the wide area network 8 is therefore transparently accessed by the plurality of network devices 10 via the local area network 6 and the secondary wide area network access device 4 via the primary wide area network access device 2.

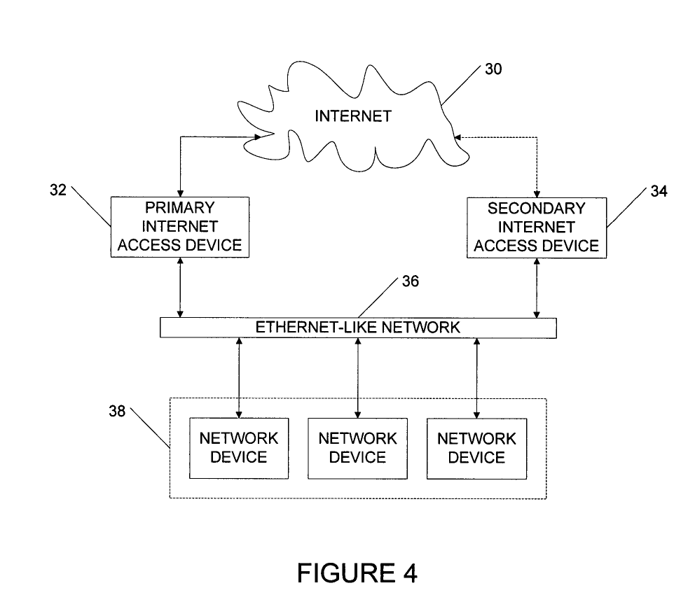

Now referring to FIG. 4, there is shown a block diagram of the passive connection backup system in the preferred embodiment of the invention.

A plurality of network devices 38 are connected to a local area network 36 which is an Ethernet-like network. Each of the plurality of network devices 38 is intended to be connected to the Internet 30. It will be appreciated that a network device may be any one of a computer, a dedicated network processing server, a router, an application gateway or the like.

In this embodiment, the passive connection backup system comprises a primary internet access device 32 and a secondary internet access device 34. The primary internet access device 32 and the secondary internet access device 34 are preferably IETF RFC-compliant internet access routers and/or bridges.

In the preferred embodiment of the passive connection backup system, the primary internet access device 32 and the secondary internet access device 34 are located on the same Ethernet-like LAN segment, that is 32 and 34 are not separated by one or more ISO layer 3 routers.

It will be appreciated that the passive connection backup system is intended to operate at the Ethernet datalink layer, which is defined by ISO layer 2. Alternatively, the passive connection backup system may also operate at the IP network layer (ISO layer 3) in order to backup DNS services for enhanced backup transparency.

The primary internet access device 32 is connected to the Internet 30 and to the local area network 36. The primary internet access device 32 therefore provides an access to the Internet 30 via the local area network 36 to the plurality of network devices 38. The primary internet access device 32 further manages the passive backup function as explained below.

The secondary internet access device 34 is connected to the Internet 30 and to the local area network 36. The secondary internet access device 34 is intended to provide a backup connection, to the Internet 30, to the plurality of network devices 38 via the Ethernet-like network 36 as explained below.

The skilled addressee will appreciate that while a connection is shown in FIG. 4 between the Internet 30 and the secondary internet access device 34, it should be understood that the said connection exists preferably only when necessary, i.e., when a failure occurs in a primary connection between the Internet 30 and the primary internet access device 32.

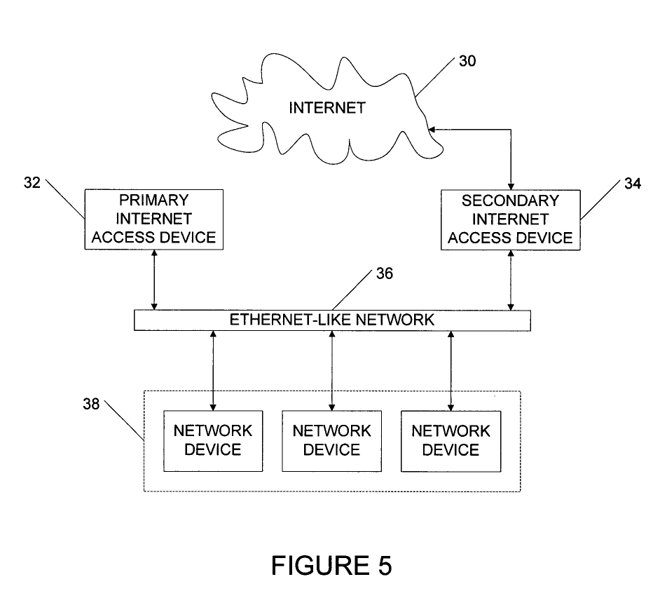

Now referring to FIG. 5, there is shown an example of the preferred embodiment of the passive connection backup system in the case where the connection between the Internet 30 and the primary internet access device 32 does not operate. It will be appreciated that the connection between the Internet 30 and the primary internet access device 32 may not operate for a plurality of reasons summarized as a failure of the Internet 30 service provider equipment.

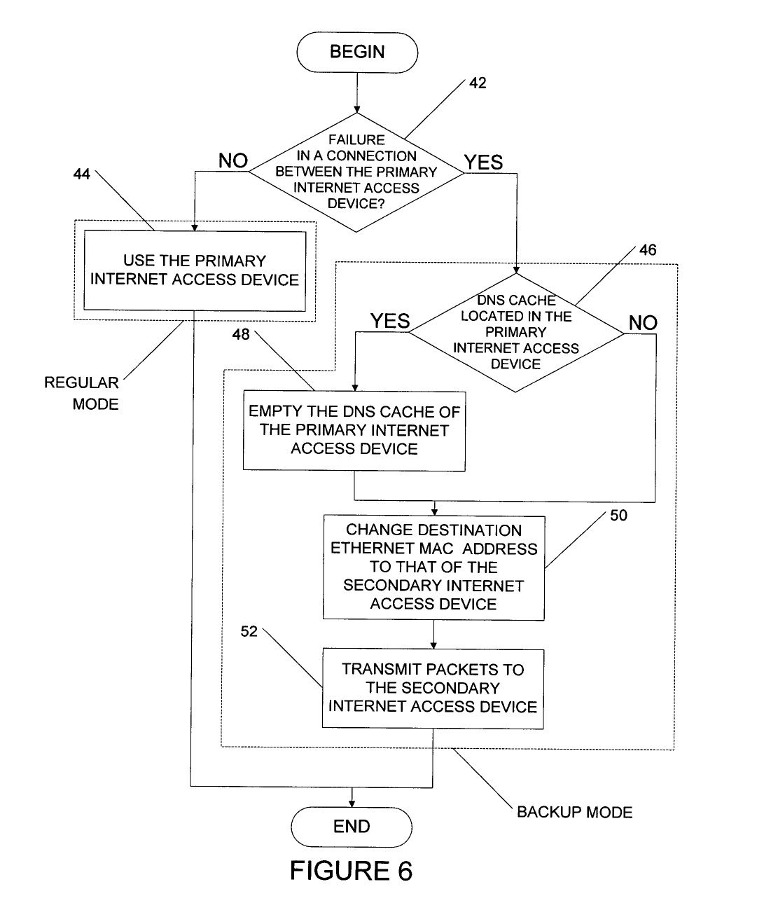

Now referring to FIG. 6, there is shown a method for providing a backup connection system in accordance with an embodiment of the invention.

According to step 42, a test is performed (as described previously, see step 20 in FIG. 3) in order to detect a failure in a connection between the primary internet access device 32 and the Internet 30.

In the case where no failure is detected in the connection between the primary internet access device 32 and the Internet 30 and according to step 44, the primary internet access device 32 is used to transmit data packets between the plurality of network devices 38 and the Internet 30. Such a state is referred to as the normal state. Incoming data packets originating from the Internet 30 and having a layer 3 destination IP address corresponding to the address of one of the plurality of network devices 38 are received by the primary internet access device 32 and transmitted to their destination address via the Ethernet-like network 36.

In the case where a failure is detected in the connection between the primary internet access device 32 and the Internet 30 and according to step 46, a test is performed in order to find out if a domain name server layer 3 IP address cache is located in the primary internet access device 32. In fact, the skilled addressee will appreciate that a domain name server cache may be advantageously created in the primary internet access device 32 in order to cache results from previous domain name server requests for future use.

In the case where a domain name server cache is located in the primary internet access device 32 and according to step 48, the domain name server cache is emptied by the primary internet access device 32.

In the case where there is no domain name server cache located in the primary internet access device 32 or upon emptying the domain name server cache, a change of the destination Ethernet Mac (Media Access Address) address of a data packet received by the primary internet access device 32 is performed by the primary internet access device 32 according to step 50.

In fact, the destination Ethernet Mac address of the data packet is replaced, by the primary internet access device 32, with the Ethernet Mac address of the secondary internet access device 34. However, it will be appreciated that aside from changing the destination Ethernet Mac address of the data packet, no further changes are performed. It will therefore be appreciated that the primary internet access device 32 is preferably operating an Internet 30 access backup procedure by relaying LAN data packets from a plurality of network devices 38 destined for the Internet 30 to the secondary internet access device 34. Furthermore, it will be appreciated that the primary internet access device 32 has an ISO layer 3 IP LAN address which is different from the IP LAN address of the secondary internet access device 34.

An ISO layer 2 ARP broadcast may be used by the primary internet access device 32 in order to discover the layer 2 address of the secondary internet access device 34.

The data packet is therefore provided to the secondary internet access device 34 and according to step 52, the secondary internet access device 34 is then used to transmit the outgoing data packet to the Internet 30.

In the case where an incoming data packet intended to be delivered to a given network device of the plurality of network devices 38, is received by the secondary internet access device 34 from the internet 30, the incoming data packet is transmitted by the secondary internet access device 34 directly to the given network device, and not via the primary internet access device 32.

An ARP request may be generated by the secondary internet access device 34 in order to find out the Ethernet address of the given network device prior to transmitting the incoming data packet to the given network device.

It will be appreciated that steps 42, 46, 48 and 50 are achieved using a software implementation; however alternatively, such steps may be achieved using a hardware implementation.

In the case where the connection between the primary internet access device 32 and the Internet 30 resumes, the primary internet access device 32 stops changing the destination Ethernet address of data packets received by the primary internet access device 32, and simply transmits outgoing data packets directly to the Internet.

Those skilled in the art will understand that the passive connection backup system may support higher ISO layer protocols such as dynamic host control protocol (DHCP) and domain name server (DNS) relay to improve passive connection backup transparency. It will be appreciated that DHCP server support on the primary internet access device 32 enables an internet access device to configure a plurality of network devices 38 IP settings at all times and also to present itself as the domain name server to avoid intra-network 36 device communication delays when an internet access connection is not established and public domain name servers located on the internet 30 are not known. The skilled addressee will therefore appreciate that configuration of a network device, which therefore uses dynamic host control protocol auto-IP configuration, is thus simplified. It will be appreciated that dynamic host control protocol and domain name server relay may or may not be implemented in the primary internet access device 32 and in the secondary internet access device 34.

It will be appreciated that domain name server requests are still sent to the primary internet access device 32 in case of a failure of the connection between the primary internet access device 32 and the Internet 30. The domain name server requests are then transmitted by the primary internet access device 32 to the secondary internet access device 34.

The skilled addressee will also appreciate that steps 42 and 46 are performed at one time (i.e. only once) preferably when switching to or from the backup state.

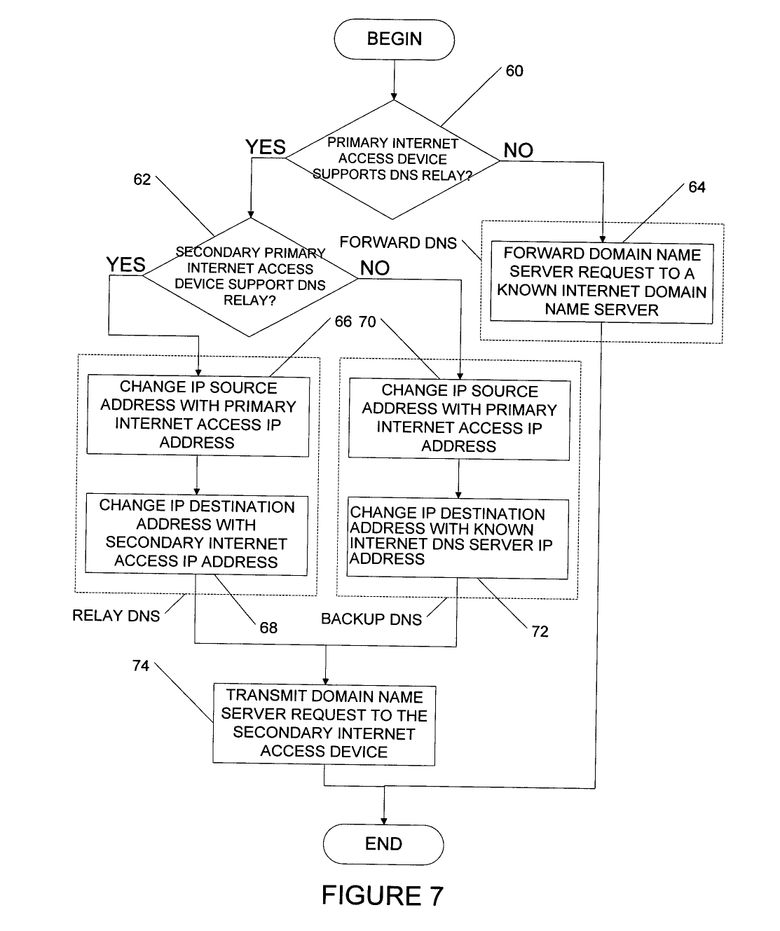

Now referring to FIG. 7, is a flow chart which shows how domain name server requests are handled by the passive connection backup system in the case of a failure of the connection between the primary internet access device 32 and the Internet 30.

According to step 60, a test is performed in order to determine if the primary internet access device 32 supports domain name server relay.

In the case where the primary internet access device 32 does not support domain name server relay and according to step 64, a domain name server request is forwarded by the primary internet access device 32 to a known internet domain name server. It will be appreciated that the ISO layer 3 destination IP address of the domain name server request is not changed as per regular (non-DNS) data packets. It will be appreciated that a domain name server should be accessible via the primary internet access device 32, the secondary internet access device 34 or an alternative route.

In the case where the primary internet access device 32 supports domain name server relay and according to step 62, a test is performed in order to find out if the secondary internet access device 34 supports domain name server relay.

In the case where the secondary internet access device 34 supports domain name server relay and according to step 66, the layer 3 IP source address of a domain name server request is changed by the primary internet access device 32 with the IP address of the primary internet access device 32.

According to step 68, the layer 3 IP destination address of a domain name server request is changed with the IP address of the secondary internet access device 34. It will further be appreciated that the layer 2 Ethernet source address of the domain name server request is changed to the Ethernet LAN address of the primary internet access device 32. Furthermore, as per with non-DNS requests, the Ethernet destination address of the domain name server request is changed to the Ethernet LAN address of the secondary internet access device 34. One skilled in the art will appreciate that these ethernet and IP address manipulations result in DNS replies being returned to the DNS-requesting LAN device by way of the primary internet access device 32.

In the case where the secondary internet access device 34 does not support a domain name server relay and according to step 70, the IP source address of a domain name server request is changed with the IP address of the primary internet access device 32.

According to step 72, the IP destination address of a domain name server request is changed with the IP address of a known Internet domain name server. It will also be appreciated that the Ethernet source address of the domain name server request is changed to the Ethernet LAN address of the primary internet access device 32. Furthermore, as for non-DNS requests, the Ethernet destination address of the domain name server request is changed with the Ethernet LAN address of the secondary internet access device 34. One skilled in the art will appreciate that these ethernet and IP address manipulations result in DNS replies being returned to the DNS requesting LAN device by way of the primary internet access device 32.

According to step 74, the domain name server request is transmitted by the primary internet access device 32 to the secondary internet access device 34.

It will be appreciated that despite a failure of the connection between the primary internet access device 32 and the Internet 30, the primary internet access device 32 may still be used by the plurality of network devices 38 in order to handle domain name server requests if the primary internet access device 32 supports domain name server relay.

In fact, it will be appreciated that reconfiguration of the domain name server IP addresses of the primary 32 and secondary 34 internet access devices is avoided on each network device of the plurality of network devices 38. The skilled addressee will appreciate that providing a DHCP service on the primary 32 to present itself as a DNS server to the plurality of network devices 38 eliminates all manual IP reconfiguration of the plurality of network devices 38 when the primary internet access device 32 changes to or from the backup state.

In the case of a transition to or from the backup state, any open TCP connections between a network device of the plurality of network devices 38 and the Internet 30 are aborted. Aborting such connections may have a minor impact for robust file-sharing Internet applications such as Gnutella and OpenNAP, or common transaction-oriented Internet applications such as email and web-based applications. In the case of Gnutella and OpenNAP, such applications are designed to be able to restart and continue aborted connections, while in the case of transaction-oriented applications short-lived TCP connections are used. A user may therefore easily retry an operation and continue using these applications after backup state transitions. However, for other applications using longer-lived TCP-based connections, such as, FTP file transfer or audio/video stream internet applications, the user must reconnect the application. Depending on the application, the reconnection may be completely automated or require manual intervention, and is therefore more dependent on the implementation of the application.

In an alternative embodiment, the primary internet access device 32 is connected to the Ethernet-like network 36 via an Ethernet bridge. An Ethernet-like network 36 may comprise multiple Ethernet or other network media such as Universal Serial Bus (USB) and IEEE 802.11 Wireless LANs capable of emulating IEEE 802.3 Ethernets, all which are interconnected in such a way as to appear as a single Ethernet.

The embodiments of the invention described above are intended to be exemplary only. The scope of the invention is therefore intended to be limited solely by the scope of the appended claims.

1. In a primary access device connecting a first network to a second network over a primary connection, a method for providing a backup connection between said first network and said second network, said method comprising:
detecting a failure in said primary connection;
receiving, at said primary access device, a data packet originating from said first network and having a destination address at the ISO datalink layer 2;
replacing, in said data packet, said destination address with a backup access device datalink address identifying a backup access device capable of providing said backup connection;
whereby said replacing of said destination address with said backup access device datalink address enables a transmittal of said received data packet to said second network over said backup connection.

2. The method as claimed in claim 1, wherein said first network is a local area network (LAN).

3. The method as claimed in claim 2, wherein said second network is a wide area network (WAN).

4. The method as claimed in claim 3, wherein said local area network is an Ethernet-like network.

5. The method as claimed in claim 4, wherein said wide area network is an IP-based network.

6. The method as claimed in claim 5, wherein said data packet is an domain name server request.

7. The method as claimed in claim 4, further comprising performing an ARP request and further wherein said backup access device datalink address is provided by said backup access device in response to said ARP request.

8. The method as claimed in claim 5, wherein said backup access device IP network station address is provided to said primary access device at a predetermined time.

9. The method as claimed in claim 5, wherein said primary access device comprises domain name server relay and cache service, further comprising emptying said cache after said detecting of said failure in said primary connection.

10. The method as claimed in claim 5, further comprising creating a direct ISO layer 2 datalink connection between said primary access device and said backup access device and further providing said data packet having destination address replaced with said backup access device address to said backup access device using said direct ISO layer 2 datalink connection.

11. A backup system for providing a backup connection between a first network and a second network in response to a failure of a primary connection between said first network and said second network, said backup system comprising:
a backup access device for providing said backup connection and having a device address at the ISO layer 2 datalink layer;
a primary access device, connected to said backup access device, providing said primary connection between said first network and said second network and, in response to said failure, replacing the destination address of an incoming data packet, at said datalink layer, with said backup access device datalink address;
whereby said replacing of said destination address with said backup access device address enables the transmittal of said data packet to said second network over said backup connection.

12. The backup system as claimed in claim 11, wherein said primary access device and said backup access device are connected using an Ethernet network.

13. The backup system as claimed in claim 11, wherein said first network is a local area network (LAN).

14. The backup system as claimed in claim 11, wherein said second network is a wide area network (WAN).

15. The backup system as claimed in claim 11, wherein said primary access device further comprises a domain name server relay.

16. The backup system as claimed in claim 11, wherein said primary access device further comprises a DHCP server.
